(19) United States
(12) Patent Application Publication
(10) Pub. No.: US 2025/0008069 A1
(43) Pub. Date: Jan. 2, 2025

(54) DISTRIBUTION APPARATUS, DISTRIBUTION METHOD AND PROGRAM

(71) Applicant: NIPPON TELEGRAPH AND TELEPHONE CORPORATION, Tokyo (JP)

(72) Inventors: Xiaotian ZHAO, Tokyo (JP); Takafumi OKUYAMA, Tokyo (JP)

(21) Appl. No.: 18/709,239

(22) PCT Filed: Nov. 15, 2021
(86) PCT No.: PCT/JP2021/041968

§ 371 Date: May 10, 2024

(51) Int. Cl. H04N 13/194; H04N 21/234; H04N 21/2662; H04N 21/472; H04N 21/81

(52) U.S. Cl. CPC H04N 13/194; H04N 21/23418; H04N 21/2662; H04N 21/472; H04N 21/8146

(57) ABSTRACT

A distribution device according to one embodiment is a distribution device for distributing stereoscopic video content of an object composed of a polygon mesh and a texture to a terminal, the device including: a first chunk creation unit configured to create pieces of first chunk data from each piece of mesh frame data representing each piece of frame data of the polygon mesh; a second chunk creation unit configured to create pieces of second chunk data from each piece of texture frame data representing each piece of frame data of the texture; and a chunk distribution unit configured to transmit, in response to a chunk distribution request from the terminal, at least one of first chunk data and second chunk data related to the chunk distribution request to the terminal.

### TECHNICAL FIELD

The present invention relates to technology for distributing stereoscopic video content such as volumetric videos and holograms.

### BACKGROUND ART

Stereoscopic video content with six degrees of freedom (6DoF), typified by volumetric videos and holograms, is known. In order to distribute such content with high quality through communication networks, in addition to using an advanced data compression technique and a communication network/system load distribution technique, it is necessary to have a mechanism for controlling the distribution of the content itself. In particular, it is important to have a mechanism for dynamically controlling the distribution of content in accordance with, for example, field-of-view information of an XR (e.g., VR, AR, MR, SR) device serving as a client, or position information of a user in a virtual space.

A volumetric video is animation data of an object, composed of polygon mesh cells (hereinafter simply referred to as “mesh”) and textures, and can be displayed and viewed on a display of an XR device by rendering together with a virtual environment on the client side.

Technologies disclosed in NPL 1 to NPL 3 are known as a technology for volumetric video distribution. NPL 1 proposes a method of rendering a volumetric video on a server side based on a movement of a user's head detected by an AR/VR device, which is a client, and transmitting it to the client as 2D data. NPL 2 proposes a method of distributing a volumetric video generated in real time to a client and rendering it on a client side. Furthermore, NPL 3 proposes a mechanism called MPEG-DASH for distributing 2D video content data. In MPEG-DASH, the 2D video content data is divided into files called chunks (or segments), and a terminal that plays back 2D video transmits a chunk file acquisition request to a data distribution server based on a manifest file that describes a list of chunk files. Such a data distribution method is also called a chunk distribution method.

### CITATION LIST

### Non-Patent Literature

NPL 1: Serhan Gul, Dimitri Podborski, Thomas Buchholz, Thomas Schierl and Cornelius Hellge, “Low-latency cloud-based volumetric video streaming using head motion prediction,” https://arxiv.org/abs/2001.06466
NPL 2: Sergio Orts-Escolano et al., “Holoportation: Virtual 3D teleportation in real-time,” https://dl.acm.org/doi/10.1145/2984511.2984517
NPL 3: MPEG-DASH, https://mpeg.chiariglione.org/standards/mpeg-dash

### SUMMARY OF INVENTION

### Technical Problem

Since a volumetric video has a large amount of data and a large bandwidth of a communication network is necessary for the distribution thereof, there is a demand for a method of efficiently distributing a volumetric video.

However, in the method proposed in NPL 1 above, since it is necessary to perform rendering for each user on the server side, the load of the server is large. Further, in the case where the number of users increases, the division of server resources may cause deterioration in the quality of the video able to be viewed by each user. Further, it is necessary to transmit the position information from the client to the server with a low latency at a high frequency, and for example, suppressing motion-to-photon latency at which VR sickness begins to occur to 20 ms or less imposes a heavy burden on both the communication network and the server.

On the other hand, in the method proposed in NPL 2 above, 4 Gbps is required for the communication band, but it is difficult for the user to always stably secure the communication band of 4 Gbps. In addition, since the load of the communication network is large, the available bandwidth of another user using the same communication network is narrowed, and the quality of experience of the other user deteriorates. Furthermore, since the 2D data is delivered frame by frame, a memory has to bear a load of loading each frame into the memory. For example, in the case where the video is played back on a computer with low performance or a network bandwidth is insufficient, the 2D data will not be buffered and the video will be interrupted frequently.

On the other hand, although it is conceivable that such a problem be solved by using the chunk distribution method, the chunk distribution method described in NPL 3 is intended for 2D video content, and must be in a data format such as MP4 format, for example.

One embodiment of the present invention has been made in consideration of the issues described above and an object thereof is to implement a chunk distribution method for stereoscopic video content.

### Solution to Problem

In order to achieve the object above, a distribution device according to one embodiment is a distribution device for distributing stereoscopic video content of an object composed of a polygon mesh and a texture to a terminal, the device including: a first chunk creation unit configured to create pieces of first chunk data from each piece of mesh frame data representing each piece of frame data of the polygon mesh; a second chunk creation unit configured to create pieces of second chunk data from each piece of texture frame data representing each piece of frame data of the texture; and a chunk distribution unit configured to transmit, in response to a chunk distribution request from the terminal, at least one of first chunk data and second chunk data related to the chunk distribution request to the terminal.

### Advantageous Effects of Invention

It is possible to implement a chunk distribution system for stereoscopic video content.

### BRIEF DESCRIPTION OF DRAWINGS

FIG. 1 is a diagram illustrating one example of an overall configuration of a distribution system according to the present embodiment.

FIG. 2 is a flowchart illustrating one example of chunk data creation processing according to the present embodiment.

FIG. 3 is a diagram schematically illustrating one example of a chunk of a polygon mesh frame.

FIG. 4 is a diagram schematically illustrating one example of chunking texture frames.

FIG. 5 is a sequence diagram illustrating one example of volumetric video playback processing according to the present embodiment.

FIG. 6 is a diagram illustrating one example of rendering of chunk data.

FIG. 7 is a diagram illustrating one example of a hardware configuration of a distribution server according to the present embodiment.

FIG. 8 is a diagram illustrating one example of a hardware configuration of a client terminal according to the present embodiment.

### DESCRIPTION OF EMBODIMENTS

One embodiment of the present invention will be described below. In the present embodiment, description will be given of a distribution system 1 for implementing a chunk distribution method for a volumetric video as one example of stereoscopic video content. The volumetric video is animation data composed of 3D data (also called three-dimensional data or stereoscopic data) of an object (including persons and animals) represented by mesh cells and textures. That is, for example, if 3D data of a frame at time t is denoted by dₜ, the volumetric video is expressed as {dₜ=(mₜ, nₜ)|t∈[tₛ, tₑ]}. mₜ denotes mesh data of a frame at time t, nₜ denotes texture data of the frame at time t, tₛ denotes the start time of the volumetric video, and the denotes the end time. Hereinafter, dₜ is also referred to as 3D frame data at time t, mₜ as mesh frame data at time t, and nₜ as texture frame data at time t. In the following description, tₛ=1 and tₑ=T for better understanding.

The embodiments described below are not limited to the volumetric video, and can be similarly applied to, for example, stereoscopic video content with six degrees of freedom such as a hologram.

### <Overall Configuration of Distribution System 1>

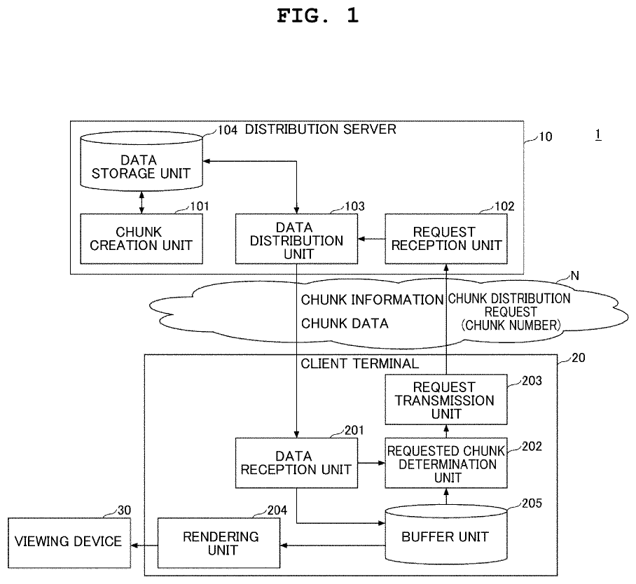

First, an overall configuration of the distribution system 1 according to the present embodiment will be described with reference to FIG. 1. FIG. 1 is a diagram illustrating one example of an overall configuration of a distribution system according to the present embodiment.

As illustrated in FIG. 1, the distribution system 1 according to the present embodiment includes a distribution server 10, a client terminal 20, and a viewing device 30. The distribution server 10 and the client terminal 20 are communicatively connected via, for example, a communication network N such as the Internet. On the other hand, the client terminal 20 and the viewing device 30 are communicatively connected by any wired or wireless connection method.

The distribution server 10 creates chunk data by dividing mesh frame data and texture frame data included in each 3D frame data constituting a volumetric video into groups called chunks, while creating chunk information including the number of each chunk (hereinafter also referred to as “chunk number”) and the data size of each chunk (hereinafter also referred to as “chunk size”).

The distribution server 10 transmits chunk information in response to a viewing start request from the client terminal 20, and transmits corresponding chunk data in response to a chunk distribution request from the client terminal 20.

The client terminal 20 can be any of various terminals (for example, PC or game machine) used by users who view the volumetric video. Based on the chunk information, the client terminal 20 determines chunk data for which a request is to be transmitted to the distribution server 10. Further, the client terminal 20 buffers the chunk data distributed from the distribution server 10, renders the chunk data, and transmits video data to the viewing device 30 as a stream.

The viewing device 30 can be any of various terminals for viewing a volumetric video, and plays back the volumetric video based on the video data received from the client terminal 20. The viewing device 30 includes, for example, an HMD (head mount display) serving as an XR (e.g., VR, AR, MR, SR) device, a smartphone or tablet terminal, or a wearable device, on which application programs functioning as XR devices are installed.

For example, in the case the client terminal 20 also serves as an XR device, the client terminal 20 may play back the volumetric video. In this case, the viewing device 30 is not required.

The distribution server 10 according to the present embodiment includes a chunk creation unit 101, a request reception unit 102, a data distribution unit 103, and a data storage unit 104.

The chunk creation unit 101 creates chunk data from the volumetric video stored in the data storage unit 104. At this time, the chunk creation unit 101 creates mesh chunk data by dividing mesh frame data included in 3D frame data constituting the volumetric video into chunks and compressing each chunk. Similarly, the chunk creation unit 101 creates texture chunk data by dividing texture frame data included in the 3D frame data constituting the volumetric video into chunks and compressing each chunk. The chunk creation unit 101 assigns a chunk number to each piece of mesh chunk data and each piece of texture chunk data and stores them in the data storage unit 104. Hereinafter, the chunk number assigned to the mesh chunk data is also referred to as the mesh chunk number, and the chunk number assigned to the texture chunk data is also referred to as the texture chunk number. Each chunk number is assigned in chronological order starting from 1.

The chunk creation unit 101 also creates chunk information including the mesh chunk number and a chunk size of the mesh chunk data of such a chunk number, and the texture chunk number and a chunk size of the texture chunk data of such a that chunk number. The chunk creation unit 101 stores the chunk information in the data storage unit 104 in association with the volumetric video.

The request reception unit 102 receives a viewing start request and a chunk distribution request from the client terminal 20. The viewing start request is a request to start viewing the volumetric video, and includes, for example, an ID of the volumetric video that a user wants to view. The chunk distribution request is a request for chunk data distribution, and includes, for example, the chunk number of the chunk data (at least one of the mesh chunk number and the texture chunk number).

In the case where the request reception unit 102 receives the viewing start request, the data distribution unit 103 transmits chunk information associated with a volumetric video having the ID included in the viewing start request to the client terminal 20 making the request. In the case where the request reception unit 102 receives the chunk distribution request, the data distribution unit 103 transmits chunk data having the chunk number included in the chunk distribution request to the client terminal 20 making the request.

The data storage unit 104 stores volumetric video, chunk data (mesh chunk data and texture chunk data) created from this volumetric video, and chunk information. The volumetric video is given an ID that uniquely identifies itself (hereinafter also referred to as a volumetric video ID).

The client terminal 20 according to the present embodiment has a data reception unit 201, a requested chunk determination unit 202, a request transmission unit 203, a rendering unit 204 and a buffer unit 205.

The data reception unit 201 receives the chunk information and the chunk data from the distribution server 10. The data reception unit 201 also buffers (temporarily stores) the chunk data received from the distribution server 10 in the buffer unit 205.

The requested chunk determination unit 202 determines chunk data for which a request is to be transmitted to the distribution server 10 based on the chunk information.

The request transmission unit 203 transmits the viewing start request to the distribution server 10 in the case where viewing the volumetric video is to be started. In the case where the requested chunk number is determined by the requested chunk determination unit 202, the request transmission unit 203 transmits the chunk distribution request including the chunk number to the distribution server 10.

The rendering unit 204 generates video data by rendering the chunk data (mesh chunk data and texture chunk data) buffered in the buffer unit 205 together with the virtual environment. The rendering unit 204 then transmits the video data as a stream to the viewing device 30.

The buffer unit 205 buffers (temporarily stores) each piece of the mesh chunk data and texture chunk data received from the distribution server 10.

### <Chunk Date Creation Processing>

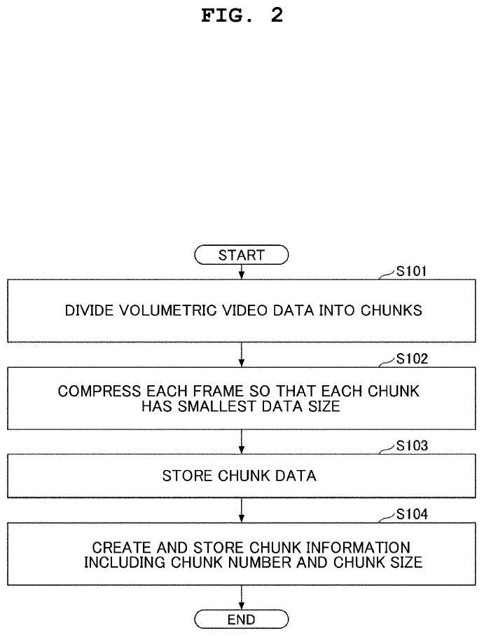

Chunk data creation processing according to the present embodiment will be described below with reference to FIG. 2. FIG. 2 is a flowchart illustrating one example of chunk data creation processing according to the present embodiment. Note that this chunk data creation processing is performed offline (that is, performed in advance prior to playback of the volumetric video).

The chunk creation unit 101 of the distribution server 10 divides each piece of mesh frame data {mₜ|t∈[1, T]} and texture frame data {nₜ|t∈[1, T]}, both included in the 3D frame data {dₜ=(mₜ, nₜ)|t∈[1, T]} constituting the volumetric video stored in the data storage unit 104, into chunks (step S101).

At this time, for the mesh frame data {mₜ|t∈[1, T]}, the chunk creation unit 101 analyzes the content of each piece of 3D frame data dₜ (or each piece of polygon mesh frame mₜ), for example, and divides the mesh frame data (mₜ|t∈[1, T]} into chunks so that the chunk size of each chunk becomes the smallest based on, for example, frame interpolation.

On the other hand, for the texture frame data {nₜ|t∈[1, T]}, the chunk creation unit 101 analyzes adjacent pieces of texture frame data, nₜ and nₜ₊₁, in order from t=1, for example, and divides the texture frame data (nₜ|t∈[1, T]} into chunks with a piece of texture frame data before a texture structure significantly changes as a chunk. For example, in the case where the texture structure changes significantly at times t₁, t₂, and t₃ (where t₁<t₂<t₃), the texture frame data is divided into 4 chunks: {nₜ|t∈[1, t₁₋₁]}, {nₜ|t∈[t₁, t₂₋₁]}, {nₜ|t∈[t₂, t₃₋₁]} and {nₜ|t∈[t₃, T]}. The case where the texture structure changes significantly means that, for example, when a texture represented by the texture frame data nₜ and a texture represented by the texture frame data nₜ₊₁ are quantified and compared for brightness, color, shade and pattern, at least some of them have changed by a predetermined threshold value or more. The case where the texture structure changes significantly may also refer to that, for example, when a texture represented by the texture frame data nₜ and a texture represented by the texture frame data nₜ₊₁ are quantified, weighted and calculated the sum for brightness, color, shade and pattern, their weighted values have changed by a predetermined threshold value or more.

It should be noted that in step S101 above, the mesh frame data and the texture frame data are divided into chunks independently of each other.

Next, the chunk creation unit 101 of the distribution server 10 compresses each piece of frame data (each piece of mesh frame data and texture frame data) so that the chunk size of each chunk divided in step S101 becomes the smallest (step S102). That is, for the mesh frame data, the chunk creation unit 101 compresses each piece of mesh frame data mₜ so that the chunk size of each chunk divided in step S101 becomes the smallest. Similarly, for the texture frame data, the chunk creation unit 101 compresses each piece of texture frame data nₜ so that the chunk size of each chunk divided in step S101 becomes the smallest. Accordingly, mesh chunk data composed of compressed mesh frame data in chunk units and texture chunk data composed of compressed texture frame data in chunk units are created.

The chunk creation unit 101 of the distribution server 10 stores the mesh chunk data and the texture chunk data created in step S101 in the data storage unit 104 (step S103). At this time, the chunk creation unit 101 assigns a mesh chunk number to each piece of mesh chunk data, and also assigns a texture chunk number to each piece of texture chunk data.

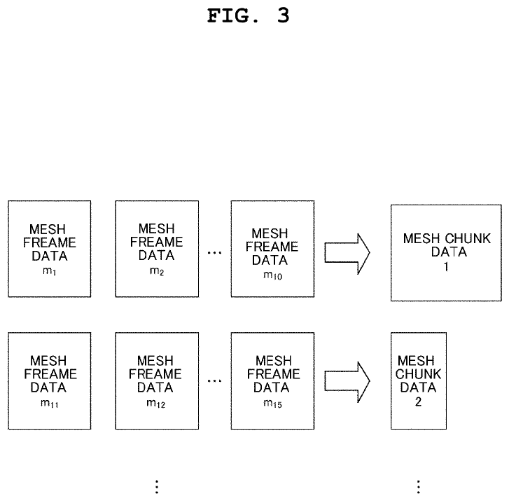

FIG. 3 shows one example of the mesh chunk data. In the example shown in FIG. 3, mesh frame data m₁ to m₁₀ are divided as one chunk, and mesh chunk data composed of data obtained by compressing each piece of mesh frame data m₁ to m₁₀ is mesh chunk data having the mesh chunk number “1”. Similarly, mesh frame data m₁₁ to m₁₅ are divided as one chunk, and mesh chunk data composed of data obtained by compressing each piece of mesh frame data m₁₁ to m₁₅ is mesh chunk data having the mesh chunk number “2”.

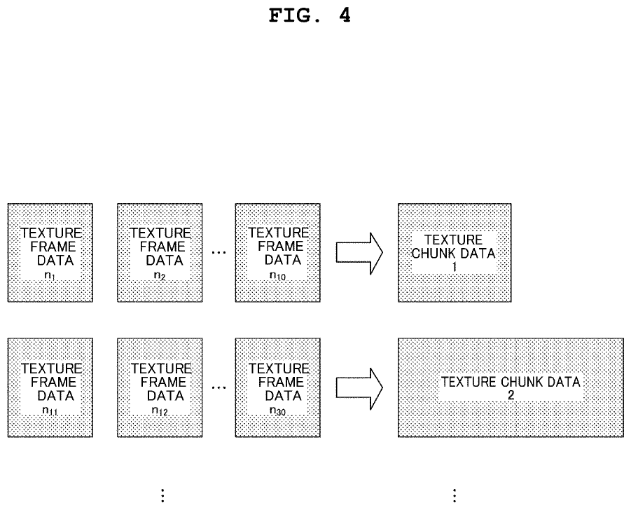

FIG. 4 shows one example of the texture chunk data. In the example shown in FIG. 4, texture frame data n₁ to n₁₀ are divided as one chunk, and texture chunk data composed of data obtained by compressing each piece of texture frame data n₁ to n₁₀ is texture chunk data having the texture chunk number “1”. Similarly, texture frame data nu to no are divided as one chunk, and texture chunk data composed of data obtained by compressing each piece of texture frame data n₁₁ to n₃₀ is texture chunk data having the texture chunk number “2”.

The chunk creation unit 101 of the distribution server 10 creates chunk information including the chunk number and the chunk size, and stores it in the data storage unit 104 in association with the volumetric video (step S104).

Specifically, the chunk information includes the mesh chunk number and a chunk size of the mesh chunk data of such a chunk number, and the texture chunk number and a chunk size of the texture chunk data of such a that chunk number.

### <Volumetric Video Playback Processing>

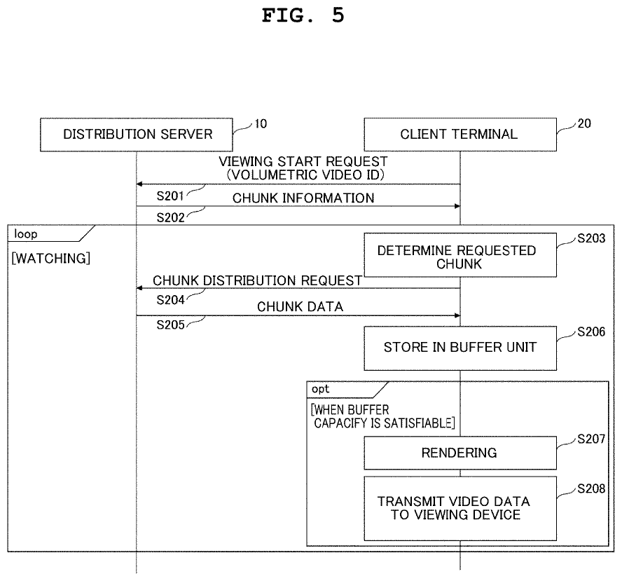

Next, volumetric video playback processing according to the present embodiment will be described with reference to FIG. 5. FIG. 5 is a sequence diagram illustrating one example of the volumetric video playback processing according to the present embodiment.

The request transmission unit 203 of the client terminal 20 transmits the viewing start request to the distribution server 10 (step S201). The viewing start request includes the volumetric video ID of the volumetric video that the user wants to view.

When the request reception unit 102 receives the viewing start request, the data distribution unit 103 of the distribution server 10 obtains the chunk information associated with the volumetric video of the volumetric video ID included in the viewing start request from the data storage unit 104, and transmits the acquired chunk information to the client terminal 20 making the request (step S202).

The following steps S203 to S208 are repeatedly performed while the user is watching the volumetric video.

The requested chunk determination unit 202 of the client terminal 20 determines a chunk number (mesh chunk number and texture chunk number) of chunk data for which a distribution request is to be transmitted to the distribution server 10 based on the chunk information (step S203). The requested chunk determination unit 202 may determine the chunk number of the chunk data for which the distribution request is to be transmitted by a method similar to a known chunk distribution method. For example, it is assumed that pieces of mesh chunk data up to mesh chunk number “k₁” and pieces of texture chunk data up to texture chunk number “k₂” have been received. In this case, the requested chunk determination unit 202 determines the mesh chunk numbers after “k₁+1” and the texture chunk numbers after “k₂+1” as the chunk numbers of the chunk data for which a distribution request is to be transmitted to the distribution server 10, based on the conditions such as the current network bandwidth and the free space of the buffer unit 205, the chunk size of the mesh chunk data the mesh chunk number after “k₁+1”, and the chunk size of the texture chunk data having the texture chunk number “k₂+1”. For example, there may be a case where only one of the mesh chunk number and the texture chunk number is determined as the chunk number of the chunk data for which the distribution request is to be transmitted to the distribution server 10.

The request transmission unit 203 of the client terminal 20 transmits a chunk distribution request including the chunk numbers (mesh chunk number and texture chunk number) determined in step S203 to the distribution server 10 (step S204). There may be a case where only one of the mesh chunk number and the texture chunk number is included in the chunk distribution request.

When the request reception unit 102 receives the chunk distribution request, the data distribution unit 103 of the distribution server 10 transmits the chunk data (mesh chunk data and texture chunk data) of the chunk number included in the chunk distribution request to the client terminal 20 making the request, out of the volumetric video chunk data of the volumetric video ID included in the viewing start request received in step S202 above (step S205).

When the data reception unit 201 of the client terminal 20 receives chunk data (mesh chunk data and texture chunk data) from the distribution server 10, it stores the chunk data in the buffer unit 205 (step S206). Therefore, the mesh chunk data and the texture chunk data are buffered in the buffer unit 205.

When the capacity of the buffer unit 205 exceeds a certain threshold th₁, the following steps S207 to S208 are executed repeatedly until the capacity falls below a certain threshold the (<th₁) in parallel with the above steps S203 to S206. For example, typically, when the buffer unit 205 becomes full, the following steps S207 to S208 are repeatedly executed in parallel with the above steps S203 to S206 until the buffer unit 205 becomes empty.

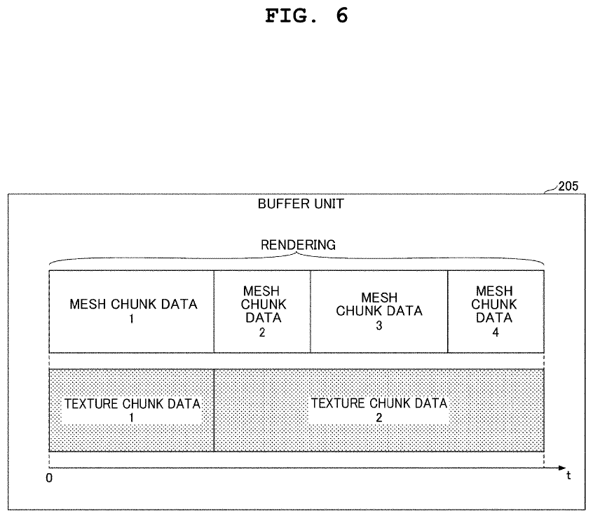

The rendering unit 204 of the client terminal 20 renders the chunk data (mesh chunk data and texture chunk data) buffered in the buffer unit 205 together with the virtual environment (step S207). Accordingly, the video data is generated. FIG. 6 shows one example of how chunk data (mesh chunk data and texture chunk data) buffered in the buffer unit 205 are rendered. In the example shown in FIG. 6, the mesh chunk data 1 of the mesh chunk number “1” to the mesh chunk data 4 of the mesh chunk number “4”, together with the texture chunk data 1 of the texture chunk number “1” to the texture chuck data “2” of the texture chunk number “2” are buffered in the buffer unit 205. Frame data (mesh frame data and texture frame data) included in these pieces of chunk data are rendered in chronological order.

The chunk data in which all the frame data are rendered is deleted from the buffer unit 205. Accordingly, new chunk data can be buffered in the buffer unit 205 in step S206.)

The rendering unit 204 of the client terminal 20 transmits the video data generated in step S207 as a stream to the viewing device 30 (step S208). Accordingly, the viewing device 30 plays back the volumetric video based on the video data received from the client terminal 20.

### <Hardware Configurations of Distribution Server 10 and Client Terminal 20>

### <Distribution Server 10>

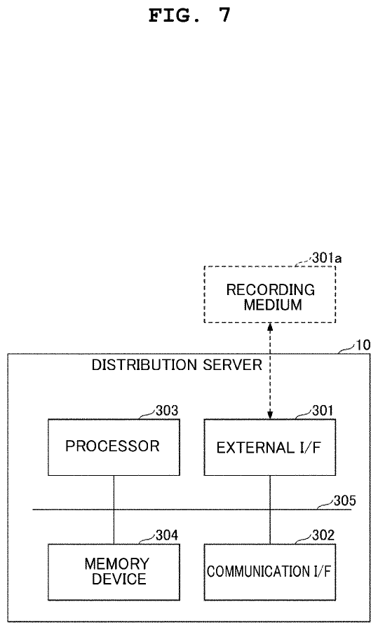

Next, a hardware configuration of the distribution server 10 according to the present embodiment will be described with reference to FIG. 7. FIG. 7 is a diagram illustrating one example of a hardware configuration of the distribution server 10 according to the present embodiment.

As shown in FIG. 7, the distribution server 10 according to the present embodiment includes an external I/F 301, a communication I/F 302, a processor 303, and a memory device 304. Each hardware is connected via a bus 305 to be able to communicate with each other.

The external I/F 301 is an interface with an external device such as a recording medium 301a. Examples of the recording medium 301a include a compact disc (CD), a digital versatile disk (DVD), a secure digital (SD) memory card, and a universal serial bus (USB) memory card.

The communication I/F 302 is an interface for connecting the distribution server 10 to a communication network N. The processor 303 is, for example, various arithmetic units such as a central processing unit (CPU). The memory device 304 is, for example, any of various storage devices such as a hard disk drive (HDD), a solid state drive (SSD), a random access memory (RAM), a read only memory rom (ROM), and a flash memory.

The distribution server 10 according to the present embodiment can implement various types of processing described above by having the hardware configuration described above. However, the hardware configuration illustrated in FIG. 7 is one example, and the distribution server 10 may have other hardware configurations. For example, the distribution server 10 may further include hardware such as an input device such as a keyboard and a mouse, and a display device such as a display. Further, for example, the distribution server 10 may have a plurality of processors 303, and may have a plurality of memory devices 304.

The chunk creation unit 101, the request reception unit 102, and data distribution unit 103 shown in FIG. 1 are implemented by, for example, processing that the processor 303 is caused to execute by one or more programs installed on the distribution server 10. The data storage unit 104 as shown in FIG. 1 is implemented by an auxiliary storage device such as an HDD or an SSD. However, the data storage unit 104 may be implemented by, for example, a database server connected to the distribution server 10 via a communication network.

### <Client Terminal 20>

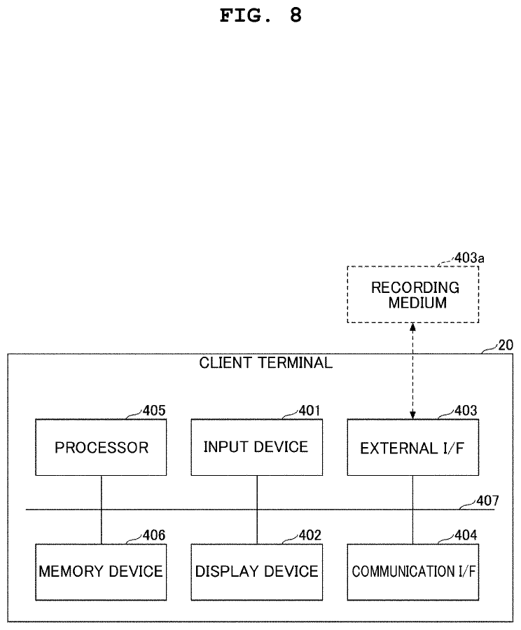

Next, a hardware configuration of the client terminal 20 according to the present embodiment will be described with reference to FIG. 8. FIG. 8 is a diagram illustrating one example of a hardware configuration of the client terminal 20 according to the present embodiment.

As shown in FIG. 8, the client terminal 20 according to the present embodiment includes an input device 401, a display device 402, an external I/F 403, a communication I/F 404, a processor 405, and a memory device 406. Each hardware is connected via a bus 407 to be able to communicate with each other.

The input device 401 is, for example, a keyboard, a mouse, or a touchscreen. The display device 402 is, for example, a display. Further, the client terminal 20 may not include at least one of the input device 401 and the display device 402.

The external I/F 403 is an interface with an external device such as a recording medium 403a. As the recording medium 403a, for example, CD, DVD, SD memory card, and USB memory card can be used.

The communication I/F 404 is an interface for connecting the client terminal 20 to the communication network N and transmitting video data to the viewing device 30. The processor 405 is, for example, any of various arithmetic units such as a CPU and a GPU (graphics processing unit). The memory device 406 is, for example, various storage devices such as HDD, SSD, RAM, ROM, and flash memory.

The client terminal 20 according to the present embodiment can implement various types of processing described above by having the hardware configuration described above. Note that the hardware configuration shown in FIG. 8 is an example, and the client terminal 20 may have another hardware configuration. For example, the client terminal 20 may include a plurality of processors 405 and may include a plurality of memory devices 406.

The data reception unit 201, the requested chunk determination unit 202, the request transmission unit 203, and the rendering unit 204 shown in FIG. 1 are implemented by causing a processor 405 to execute one or more programs installed in the client terminal 20. The buffer unit 205 shown in FIG. 1 is implemented with, for example, the memory device 406.

### <Conclusion>

As described above, the distribution system 1 according to the present embodiment independently chunks the mesh frame data and the texture frame data included in the 3D frame data constituting the volumetric video when adopting the chunk distribution method. Accordingly, each chunk of mesh frame data and each chunk of texture frame data can be compressed at a high compression rate, and the chunk size of mesh chunk data and the chunk size of texture chunk data can be reduced. Therefore, it is possible to reduce the processing load of the client terminal 20, and it is possible to play back even stereoscopic video content such as volumetric video with less interruptions, which has a large data size compared to 2D video content.

The present invention is not limited to the specifically disclosed embodiments, and various modifications, changes, combinations with known techniques, and the like can be made without departing from the scope of the claims.

### REFERENCE SIGNS LIST

1 Distribution system
10 Distribution server
20 Client terminal
30 Viewing device
101 Chunk creation unit
102 Request reception unit
103 Data distribution unit
104 Data storage unit
201 Data reception unit
202 Requested chunk determination unit
203 Request transmission unit
204 Rendering unit
205 Buffer unit
301 External I/F
301a Recording medium
302 Communication I/F
303 Processor
304 Memory device
305 Bus
401 Input device
402 Display device
403 External I/F
403a Recording medium
404 Communication I/F
405 Processor
406 Memory device
407 Bus
N Communication network

1. A distribution device for distributing stereoscopic video content of an object composed of a polygon mesh and a texture to a terminal, the device comprising:
a memory; and
a processor coupled to the memory and configured to:
create pieces of first chunk data from each piece of mesh frame data representing each piece of frame data of the polygon mesh;
create pieces of second chunk data from each piece of texture frame data representing each piece of frame data of the texture; and
transmit, in response to a chunk distribution request from the terminal, at least one of first chunk data and second chunk data related to the chunk distribution request to the terminal.

2. The distribution device according to claim 1, wherein the processor is further configured to analyze each piece of mesh frame data or each piece frame data of the stereoscopic video content, and each piece of mesh frame is divided into a plurality of chunks based on frame interpolation such that each chunk has the smallest size, thereby creating the pieces of first chunk data.

3. The distribution device according to claim 1, wherein the processor is further configured to analyze pieces of texture frame data of mutually adjacent times among the texture frame data in chronological order, and in a case where a structure of the texture has changed more than a predetermined amount between pieces of texture frame data at mutually adjacent times, each texture frame data before the structure of the texture changes more than a predetermined amount is regarded as one chunk, and each piece of texture frame data is divided into a plurality of chunks, thereby creating the pieces of second chunk data.

4. The distribution device according to claim 3, wherein the structure of the texture is at least one of brightness, color, shading, and pattern of the texture.

5. The distribution device according to claim 1, wherein the processor is further configured to:
create chunk information including a chunk number and data size of each of the pieces of first chunk data and a chunk number and data size of each of the pieces of second chunk data; and
transmit, in response to a viewing start request from the terminal, chunk information related to the viewing start request to the terminal,
wherein the chunk distribution request includes a chunk number determined by the terminal based on the chunk information.

6. A distribution method, executed by a computer for distributing stereoscopic video content of an object, composed of a polygon mesh and a texture to a terminal, the method comprising:
creating pieces of first chunk data from each piece of mesh frame data representing each piece of frame data of the polygon mesh;
creating pieces of second chunk data from each piece of texture frame data representing each piece of frame data of the texture; and
transmitting, in response to a chunk distribution request from the terminal, at least one of first chunk data and second chunk data related to the chunk distribution request to the terminal.

7. A non-transitory computer-readable recording medium having a program embodied therein for causing a computer to perform the method of claim 6.
